(19) United States
(12) Patent Application Publication
(10) Pub. No.: US 2025/0252862 A1
(43) Pub. Date: Aug. 7, 2025

(54) USING AND TRAINING AN ENGAGEMENT SCORE INITIALIZER TO DETERMINE AN INITIAL ENGAGEMENT SCORE FOR CONTENT TO PRESENT TO A USER

(71) Applicant: INTERNATIONAL BUSINESS MACHINES CORPORATION, ARMONK, NY (US)

(72) Inventors: Su Liu, Austin, TX (US); Jun Su, Beijing (CN); Douglas Brian Mueller, Apex, NC (US); YANG LIANG, Beijing (CN)

(21) Appl. No.: 18/435,804

(22) Filed: Feb. 7, 2024

(51) Int. Cl. G09B 5/02; G06F 18/2415

(52) U.S. Cl. CPC G09B 5/02; G06F 18/2415

(57) ABSTRACT

Provided are a computer program product, system, and method for using and training an engagement score initializer to determine an initial engagement score for content to present to a user. A request is received, from a requesting user, for a content instance in a requested domain. An engagement score initializer determines an initial engagement score, for the requesting user, based on the requested domain, a complexity level of the content instance and a knowledge level of the user. A determination is made as to whether the initial engagement score, for the requesting user, exceeds an engagement threshold. The content instance is provided to render at a client system of the requesting user in response to the initial engagement score exceeding the engagement threshold.

### BACKGROUND OF THE INVENTION

### 1. Field of the Invention

The present invention relates to a computer program product, system, and method for using and training an engagement score initializer to determine an initial engagement score for content to present to a user.

### 2. Description of the Related Art

Education has undergone a significant transformation in recent years, driven by advances in technology, data analytics, and a growing recognition of the importance of personalized learning. Traditional one-size-fits-all approaches to education are being replaced with more individualized and adaptive methods. This shift is fueled by several key technological and educational trends. Artificial Intelligence driven platforms analyze data from students' performance and learning patterns to customize the delivery of course content. This means adjusting the pace for slow learners and providing supplementary material for quick learners. The goal is to tailor educational experiences to match these individual attributes, optimizing learning outcomes. By personalizing educational experiences based on individual needs, preferences, and emotional states, educators aim to enhance student engagement, motivation, and achievement.

### SUMMARY

Provided are a computer program product, system, and method for using and training an engagement score initializer to determine an initial engagement score for content to present to a user. A request is received, from a requesting user, for a content instance in a requested domain. An engagement score initializer determines an initial engagement score, for the requesting user, based on the requested domain, a complexity level of the content instance and a knowledge level of the user. A determination is made as to whether the initial engagement score, for the requesting user, exceeds an engagement threshold. The content instance is provided to render at a client system of the requesting user in response to the initial engagement score exceeding the engagement threshold.

### BRIEF DESCRIPTION OF THE DRAWINGS

FIG. 1 illustrates a network computing environment to determine content to present to a user.

FIG. 2 illustrates an embodiment of an engagement monitor to monitor user reactions to presented content.

FIG. 3 illustrates an embodiment of initial engagement score information generated for a domain, class complexity, and user knowledge level.

FIG. 4 illustrates an embodiment of class criteria to select a class for a user.

FIG. 5 illustrates an embodiment of a class recommendation data structure providing information on a class to select for a user.

FIG. 6 illustrates an embodiment of a training set instance to train an engagement score initializer.

FIG. 7 illustrates an embodiment of operations to generate an initial engagement score for a user.

FIG. 8 illustrates an embodiment of operations to determine whether to provide a class to a user.

FIGS. 9A and 9B illustrate an embodiment of operations for an engagement analyzer to determine an engagement score based on user reaction to observing the class content.

FIG. 10 illustrates a graph showing a relationship of calculated engagement score and challenge level for a user observing a class to determine whether to recommend a new class for the user.

FIG. 11 illustrates calculated engagement scores for users observing a class and new class recommendations based on the engagement score and challenge level for the user mapping to the graph of FIG. 10.

FIG. 12 illustrates an embodiment of operations to train the engagement score initializer to calculate an initial engagement score estimating user engagement with respect to class content.

FIG. 13 depicts a computing environment in which the components of FIGS. 1 and 2 may be implemented.

### DETAILED DESCRIPTION

Described embodiments provide improvements to machine learning model computer technology deployed in content selection for a user by using an engagement score initializer machine learning model to estimate an initial user engagement score with respect to content instances. Described embodiments use machine learning models to calculate a user engagement score in real-time while engaged with the content. Differences between the calculated engagement score and the estimated initial engagement score may be used to retrain the engagement score initializer machine learning model to provide an initial estimate of the engagement score to improve the selection of content to present to a user.

Described embodiments utilize machine learning models to classify user reaction to class content to determine emotional states of the user while engaged with the content to provide emotion based class recommendations. Described embodiments leverage engagement and emotion data to recommend classes that align with a student's emotional state to improve the emotional experience of learning, enhance motivation and reduce negative emotions such as frustration.

Described embodiments provide real-time engagement and emotion data analysis by integrating Internet of Things (IoT) sensors to perform real-time data collection and analysis of engagement and emotional states. This allows analysis of student emotional states during online classes to provide dynamic real-time insights into the student engagement and emotional well-being.

Described embodiments further provide multi-dimensional student profiling that considers multiple dimensions such as emotional states, student skill levels, student knowledge levels, and class complexity levels.

Described embodiments further provide dynamic adaptation of the engagement score initializer machine learning model based on real-time data and user feedback to train the machine learning model to compensate for the evolving needs of students.

Though this disclosure pertains to the collection of personal data (e.g., user attributes, e.g., education level, work experience, areas of study, complexity level of completed classes in domains, skills, proficiency records, badges, speed preferences, complexity of completed classes in domains, historical and real time behavior history for classes per domain, etc.; user behavioral attributes, e.g., eye gazing points, facial expressions, head gestures, distract, focus, blank stare, etc.; and user emotional states, e.g., challenge. relaxed, enjoyed, happy, frustrated, bored, etc.), it is noted that in embodiments, users opt into the system. In doing so, users (or their guardians) are informed of what data is collected and how it will be used, that any collected personal data may be encrypted while being used, that the users can opt-out at any time, and that if they opt out, any personal data of the user is deleted.

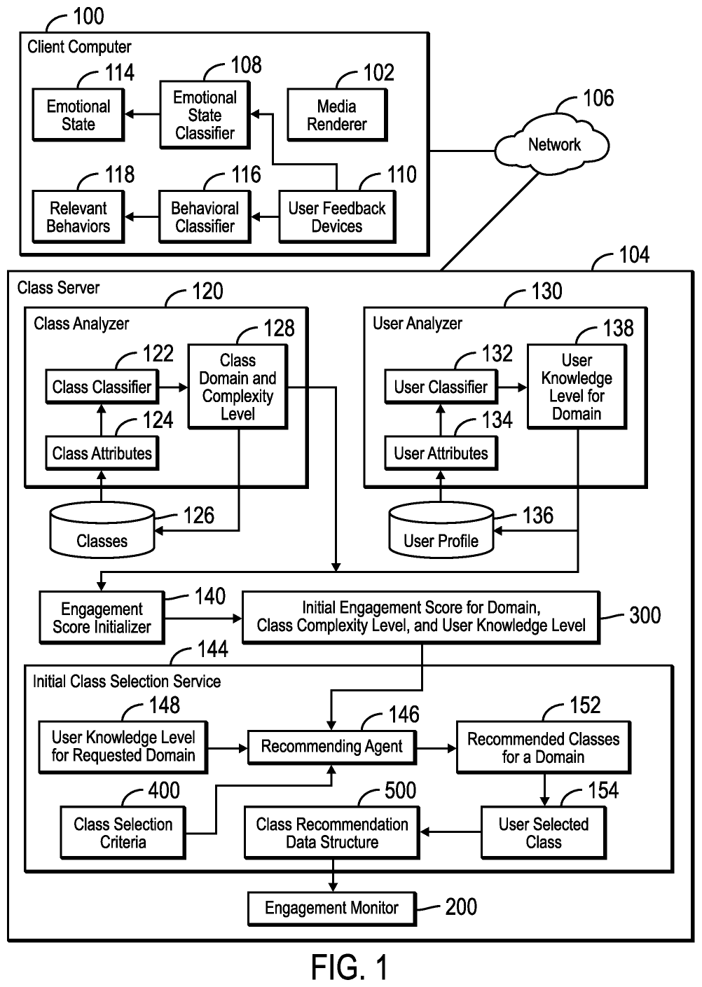

FIG. 1 illustrates an embodiment of a network computing environment having a client computer 100 that includes a media renderer 102, such as a video player or other content renderer, to play videos for a class streamed from a class server 104 over a network 106. The client computer 100 includes user feedback devices 110 to gather user feedback during user observation of the classes rendered in the media renderer 102. The feedback devices 110 may comprise Internet of Things (IoT) devices, such as gaze tracking device or glasses, cameras, microphones, wearable devices, biometric sensors, haptic sensors, and environmental sensors to observe user reactions to the class content presented in the media renderer 102. An emotional state classifier 108 in the client computer 100 may classify observed user reactions, such as from the user feedback devices 110, as emotional states 114 comprising classifications of observed user reactions (e.g., facial expressions, head gestures, distract, focus, blank stare, etc.) as challenged, relaxed, enjoyed, happy, frustrated, bored, etc. The client computer 100 may further include a behavioral classifier 116 to receive as input, from the feedback devices 110, user behaviors, e.g., eye gazing points, facial expressions, head gestures, distract, focus, blank stare, with respect to interacting with the content in the media renderer 102, to output scores for relevant behaviors 118, such as scores for active participation in class discussions, engage with hands-on lab, attendance, and completion of assignments.

The class server 104 includes a class analyzer 120 including a machine learning model class classifier 122 that receives class attributes 124 on classes from a classes database 126 having information on offered classes, such as textual descriptions of the class, indicated complexity, required education background, and outputs a class domain and complexity level 128, which may be added to class information in the classes database 126.

The class server 104 further includes a user analyzer 130, including a user classifier 132, comprising a machine learning model classifier, that receives user attributes 134 on users of the client computers 100 from a user profile database 136. The user attributes 134 may include users' education level, skills, proficiency records, badges, speed preferences, complexity of completed classes for domains, engagement behavior history and real-time for classes per domain. The user classifier 132 outputs, from the received user attributes 134, a user knowledge level for a domain 138. The user knowledge level for a domain 138 and the class domain and complexity level 128 are provided as input to an engagement score initializer 140 which outputs an initial engagement score 300 for the input domain, class complexity level, and user knowledge level. As shown with respect to FIG. 3, an instance of an initial engagement score 300; indicates a domain 302, a complexity level 304, a user knowledge level 306, and an initial engagement score 308 generated by the engagement score initializer 140.

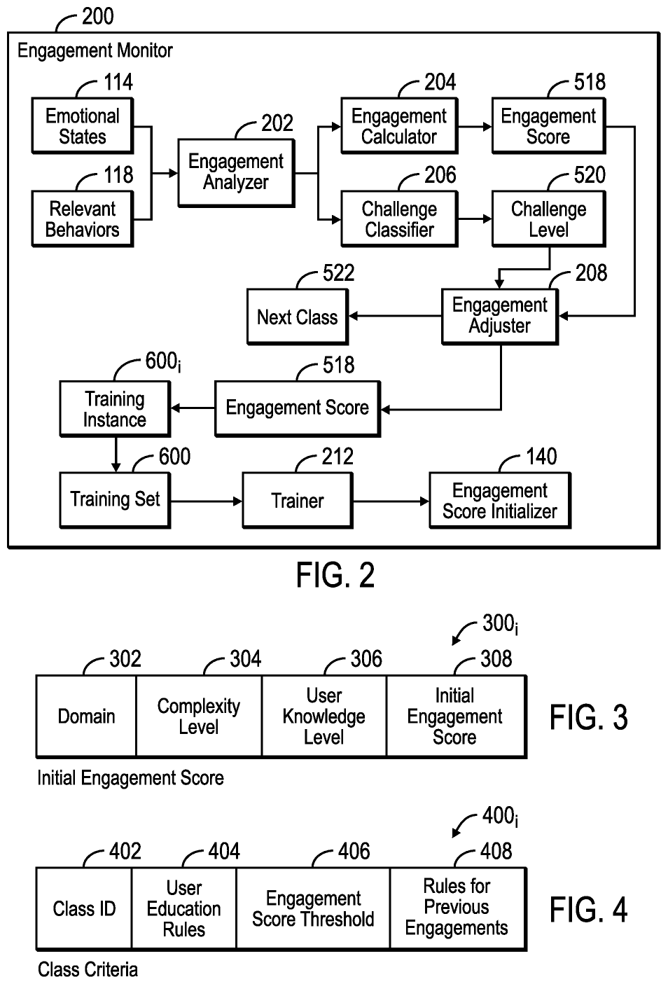

The class server 104 includes an initial class selection service 144 to select one or more classes for a requesting user in a requested domain. A recommending agent 146 comprises a program that receives a user knowledge level of the requesting user for a requested domain 148, initial engagement scores 300 for the requested domain and knowledge level of the requesting user for different class complexities, and class selection criteria 400 to determine recommended classes 152 for a domain for the requesting user. As shown in FIG. 4, an instance of a class selection criteria 400 for a class may comprise a class identifier (ID) 402 identifying a class; user education rules 404, such as education background requirements and required previously taken classes 126; an engagement score threshold 406 required for the user to take the class; and rules for previous engagements 408, such as previously taken classes, previous engagement scores for related classes, emotional and behavioral requirements while taking related classes, etc. The requesting user may select a class 154 from the recommended classes 152. A class recommendation data structure 500 is generated to track information on user engagement with the selected class 154 rendered in the media renderer 102 at the client computer 100 of the requesting user. The class recommendation data structure 500 is provided to the engagement monitor component 200, described with respect to FIG. 2.

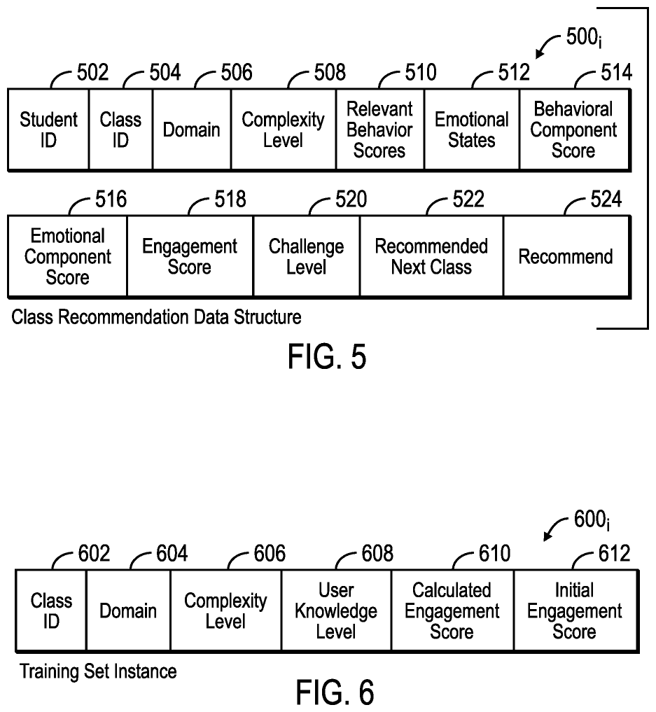

With respect to FIG. 5, a class recommendation data structure instance 500; for a class may include: a student ID 502 of the requesting user selecting the class; a class ID 504 of the class to be rendered at the client computer 100; a domain 506 of the class; the complexity level 508 determined for the class; relevant behavior scores 510 concerning user behavior collected from the feedback devices 110 and analyzed by the behavioral classifier 116 at the client computer 100, such as active participation in class, engagement with hands-on lab; attendance; and completion of assignments; emotional states 512 of the user while observing the class, such as challenged, relaxed, enjoyed, happy, frustrated, bored, etc., generated by the emotional state classifier 108 processing images and biometrics of the user from the user feedback devices 110; a behavioral component score 514 calculated as a function of the relevant behavioral scores 510, such as a sum of weighted behavioral scores; an emotional component score 516 calculated as a function of the emotional states 512, such as a sum of weighted emotional states 512; an engagement score 518 which may be calculated as a sum of the weighted behavioral component score 514 and the weighted emotional component score 516; a challenge level 520 indicating an extent to which the user 502 was challenged or not challenged from the class 504; a recommended new class 522 provided if the user was not sufficiently engaged according to the engagement score 518 and was not challenged or was over-challenged by the class 504 material; and a recommend field 524 indicating whether a new class 522 was recommended.

The engagement monitor 200 includes an engagement analyzer 202 component that receives the emotional states 114 and relevant behaviors 118 from the client computer 100 and forwards to an engagement calculator 204 to calculate an engagement score 518. The engagement calculator 204 calculates the behavioral component score 514 from the relevant behavior scores 510 for the received relevant behaviors 118 and calculates the emotional component score 516 from the emotional states 512. The engagement score 518 may be calculated as a function of the behavioral component score 514 and the emotional component score 516. The different scores 514, 516 518 may be calculated as a sum of weighted components. For instance, the behavioral component score 514 may be calculated a sum of weighted relevant behavior scores 510, the emotional component score 516 may be calculated as a sum of weighted emotional states 114, and the engagement score 518 may be calculated a sum of the weighted behavioral component score 514 and the emotional component score 516.

The engagement analyzer 202 further forwards the emotional states 114 and relevant behaviors 118, which be digitized as relevant behavior scores 514, to a challenge classifier 206, which may comprise a machine learning model classifier, to produce a challenge level 520 indicating an extent to which the user was challenged or not challenged.

An engagement adjuster program 208 receives the engagement score 518 and challenge level 520 and determines whether to determine a next class 522 to recommend for the user to take. If the calculated real-time engagement score 518 is below a threshold and differs from the initial engagement score determined for the user for the class, then the engagement adjuster 208 includes the calculated engagement score 518 in a training instance 600ᵢ to include in a training set 600 comprising a matrix of training instances 600ᵢ. A trainer program 212 may use the training set 600 to retrain the engagement score initializer 140 using back propagation.

FIG. 6 illustrates an embodiment of a training set instance 600ᵢ, and may include a class ID 602 indicating the class for which the training set is generated; a domain 604 of the class 602; a complexity level 606 of the class, such as determined by the challenge classifier 206; a user knowledge level 608 of the user that was observing the class 602 content, as determined by the user classifier 132; the calculated engagement score 610 from the engagement calculator 204; and the initial engagement score 612, comprising the initial engagement score 300 from the engagement score initializer 140.

Generally, program modules, such as the program components 102, 108, 116, 120, 122, 130, 132, 140, 146, 200, 202, 204, 206, 208, 212, among others, may comprise routines, programs, objects, components, logic, data structures, and so on that perform particular tasks or implement particular abstract data types.

The programs 102, 108, 116, 120, 122, 130, 132, 140, 146, 200, 202, 204, 206, 208, 212, among others, may comprise program code loaded into memory and executed by a processor. Alternatively, some or all of the functions of these components may be implemented in hardware devices, such as in Application Specific Integrated Circuits (ASICs), Field Programmable Gate Arrays (FPGAs) or executed by separate dedicated processors.

The functions described as performed by the program components 102, 108, 116, 120, 122, 130, 132, 140, 146, 200, 202, 204, 206, 208, 212, among others, may be implemented as program code in fewer program modules than shown or implemented as program code throughout a greater number of program modules than shown

The client computer 100 may comprise a personal computing device, such as a laptop, desktop computer, tablet, smartphone, wearable computer, mixed reality display, virtual reality display, augmented reality display, etc. The class server 104 may comprise one or more server class computing devices, or other suitable computing devices.

In described embodiments, the class analyzer 120, user analyzer 130, initial class selection service 144, and engagement monitor 200 may be maintained in the class server 104. In alternative embodiments, some are all of these components 120, 130, 144, and 200 may be maintained in the client computer 100 to perform these operations locally in the client for videos stored in the client computer 100. Further, components described as implemented in the client, such as components 108 and 116, may be implemented in the class server 104.

In FIG. 1, arrows are shown between components in the client computer 100 and class server 104. These arrows represent information flow to and from the program components.

The network 106 may comprise a Storage Area Network (SAN), Local Area Network (LAN), Intranet, the Internet, Wide Area Network (WAN), peer-to-peer network, wireless network, arbitrated loop network, etc.

Certain of the program components, such as 108, 116, 122, 132, 140, 146, 206, 208, 212, may use machine learning and deep learning algorithms, such as decision tree learning, association rule learning, neural network, inductive programming logic, support vector machines, Bayesian network, Recurrent Neural Networks (RNN), Feedforward Neural Networks, Convolutional Neural Networks (CNN), Deep Convolutional Neural Networks (DCNNs), Generative Adversarial Network (GAN), etc. For artificial neural network program implementations, the neural network may be trained using backward propagation to adjust weights and biases at nodes in a hidden layer to produce their output based on the received inputs. In backward propagation used to train a neural network machine learning module, biases at nodes in the hidden layer are adjusted accordingly to produce the output having specified confidence levels based on the input parameters. For instance, the input to the engagement score initializer 140 may comprise information on complexity level of a class in a domain, user knowledge level of domain. The engagement score initializer 140 may output an estimated initial engagement score 300 indicating the engagement level for a user having a user knowledge level for a domain and a class in the domain having a complexity level. The machine learning models 108, 116, 122, 132, 140, 146, 206, 208, 212 may be trained to produce their output for product information and product recommendations, respectively, based on the inputs. Backward propagation may comprise an algorithm for supervised learning of artificial neural networks using gradient descent. Given an artificial neural network and an error function, the method may use gradient descent to find the parameters (coefficients) for the nodes in a neural network or function that minimizes a cost function measuring the difference or error between actual and predicted values for different parameters. The parameters are continually adjusted during gradient descent to minimize the error.

In an alternative embodiment, the components 108, 116, 122, 132, 140, 146, 206, 208, 212, may be implemented not as a machine learning model but implemented using a rules based system to determine the outputs from the inputs. The components 108, 116, 122, 132, 140, 146, 206, 208, 212 may further be implemented using an unsupervised machine learning module, or machine learning implemented in methods other than neural networks, such as multivariable linear regression models.

Components implemented as a machine learning model may be implemented in programs in memory or in a hardware accelerator or an inference engine.

In described embodiments, the content, for which the engagement determinations are made, that is rendered at the client computer 100, comprises digital content for educational material, such as classes and courses, such as offered as part of a Massive Open Online Course (MOOC) platform. In alternative embodiments, the content being determined to provide to users may comprise digital content and media other than for classes, such as digital entertainment, video games, classes offered by an educational institution, such as a college or university, etc.

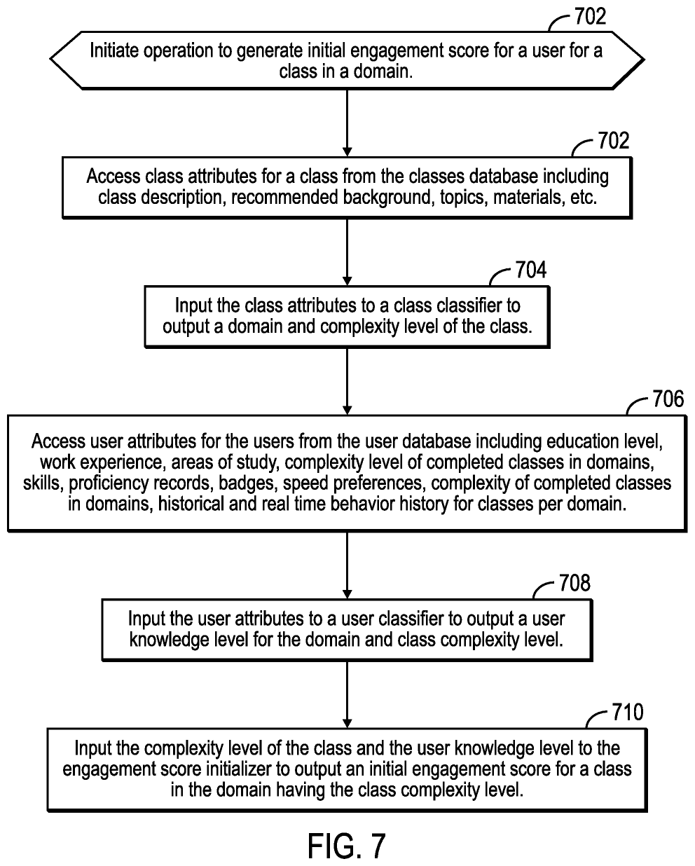

FIG. 7 illustrates an embodiment of operations performed by the components 128, 138, 140 to generate an initial engagement score 300 for a user for a class in a domain. The operations of FIG. 7 may be performed repeatedly for all currently available classes 126 in a domain to determine the initial engagement score for a user, complexity level, and a knowledge level in the domain with respect to the classes 126. The class analyzer 120 accesses (at block 702) class attributes 124 for a class from the classes database 126, including class description, recommended background, topics, materials, etc., and inputs (at block 704) the class attributes 124 to a class classifier 122 to output a domain and complexity level of the class 128. The user analyzer 130 accesses (at block 706) user attributes 134 for the users from the user database 136, such as education level, work experience, areas of study, complexity level of completed classes in domains, skills, proficiency records, badges, speed preferences, complexity of completed classes in domains, historical and real time behavior history for classes per domain, and inputs (at block 708) the user attributes 134 to a user classifier 132 to output a user knowledge level for the domain 138. The engagement score initializer 140 receives (at block 710) the complexity level of the class 128 and the user knowledge level 138 for the domain as input and outputs an initial engagement score 300 for a user having the user knowledge level 138 for a class in the domain having the class complexity level.

The embodiment of FIG. 7 provides a machine learning model technique to determine an initial engagement score 300 for a user having a knowledge level in a domain to estimate user engagement for a class in a domain having a complexity level 128. This initial engagement score 300 may be used to determine the suitability of a class for a user and to recommend classes to a user with which the user is likely to be engaged.

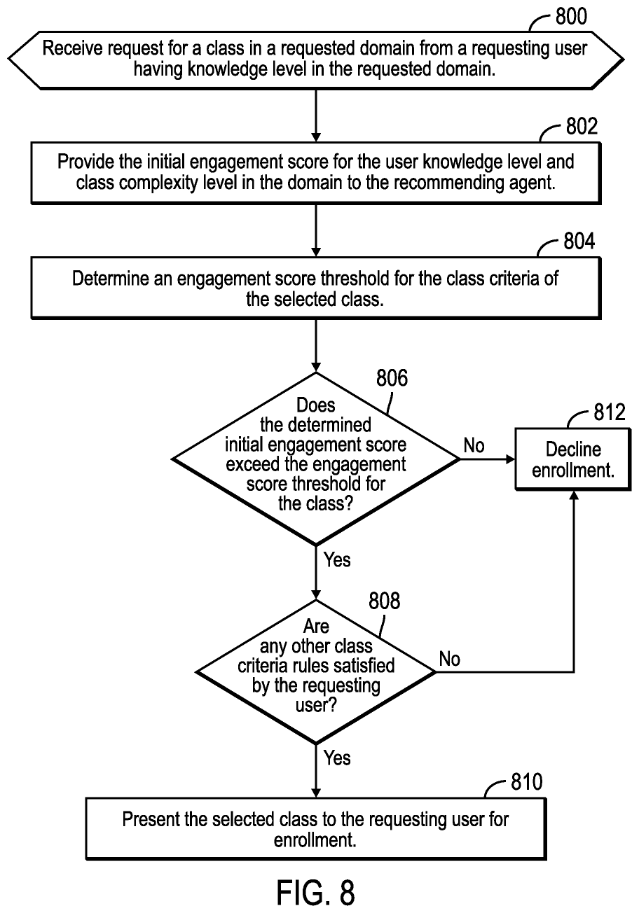

FIG. 8 illustrates an embodiment of operations performed by the initial class selection service 144 to recommend a class to a user. Upon receiving (at block 800) a request for a class in a requested domain from a requesting user having a knowledge level in the requested domain 148, the initial engagement score 308 for the domain and complexity of the class and knowledge level of the requesting user are provided (at block 802) to the recommending agent 146. The recommending agent 146 determines (at block 804) an engagement score threshold 406 from the class criteria 400 for the selected class. If (at block 806) the determined initial engagement score exceeds the engagement score threshold 406 for the selected class and if (at block 808) there are any other class criteria rules 404, 408, and others that the requesting user also satisfies, then the recommending agent 146 presents (at block 810) the selected class to the requesting user for enrollment. If (at block 806) the initial engagement score is below the engagement score threshold 406, indicating likely low engagement with the class or if (at block 808) the class criteria 400 are not satisfied, then the opportunity to enroll in the class is declined (at block 812).

The operations of FIG. 8 may be performed repeatedly for all classes 126 in a user requested domain to determine classes in which the user is eligible to enroll. Described embodiments utilize the estimated initial engagement score 308 and class criteria 400 to determine whether to enroll a user in a class or suggest a class to a user to optimize content or class selection.

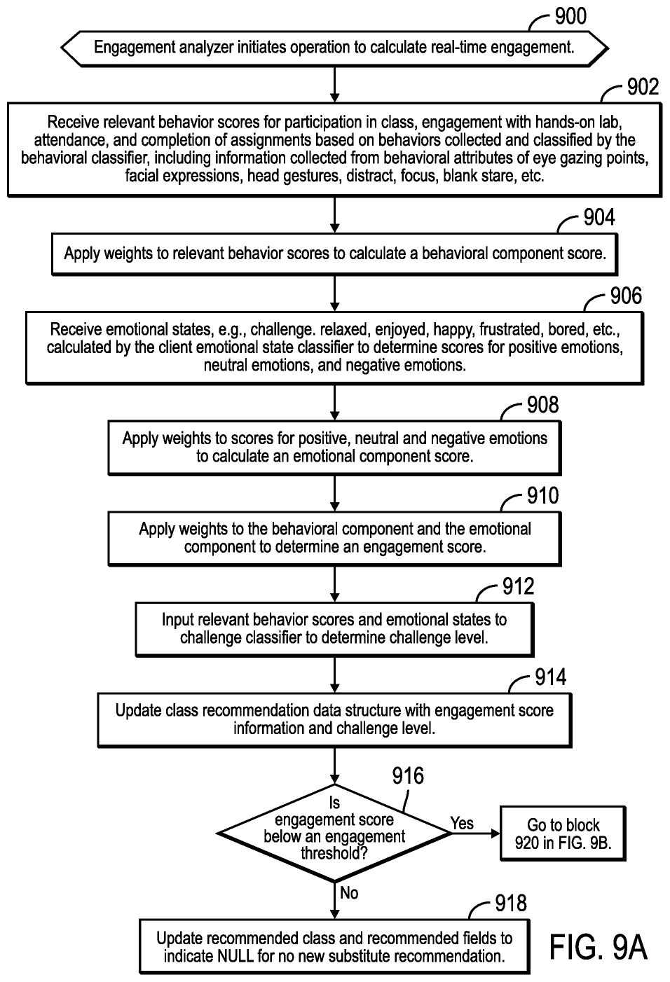

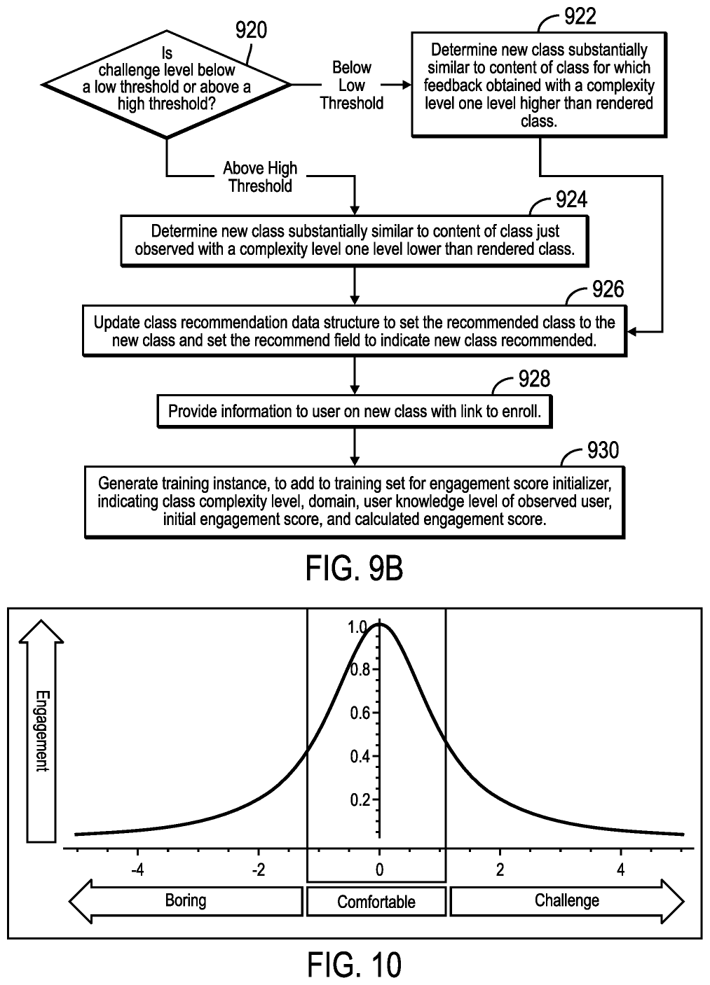

FIGS. 9A and 9B illustrate an embodiment of operations performed by the engagement monitor 200 to calculate a real-time engagement score 518 based on measured observations of user reaction to the rendered class content. Upon initiating operations (at block 900) to calculate a real-time engagement score with respect to a class being observed by a user at the client computer 100, the engagement analyzer 202 receives (at block 902) relevant behaviors behavior scores 118 for relevant behaviors, such as participation in class, engagement with hands-on lab, attendance, and completion of assignments. The relevant behavior scores 118 may be calculated by the client behavioral classifier 116 from behavioral information collected by the user feedback devices 110, including behavioral attributes of eye gazing points, facial expressions, head gestures, distract, focus, blank stare, etc. The engagement calculator 204 applies (at block 904) weights to relevant behavior scores 118 to calculate a behavioral component score 514. The engagement analyzer 202 receives (at block 906) emotional states 114, e.g., challenge. relaxed, enjoyed, happy, frustrated, bored, etc., calculated by the client emotional state classifier 108, to determine scores for positive emotions, neutral emotions, and negative emotions. The engagement calculator 204 applies (at block 908) weights to scores for positive, neutral and negative emotions to calculate an emotional component score 516. The engagement calculator 204 further applies (at block 910) weights to the behavioral component and the emotional component to determine the engagement score 518.

The engagement analyzer 202 may further input (at block 912) the emotional states 114 and relevant behaviors 118 to the challenge classifier 206 to determine a challenge level 520 indicating an extent to which the user was challenged or not challenged when observing the class material at the client computer 100. The class recommendation data structure 500; is updated (at block 914) with calculated engagement score information 510, 512, 514, 516 and calculated challenge level 520. If (at block 916) the engagement score 518 is above an engagement threshold, which may comprise the class engagement score threshold 406 or some other engagement threshold, indicating the user is sufficiently engaged with the class to indicate the class is suitable for the user, then the recommended class 522 and recommend 524 field are indicated (at block 918) as NULL to indicate there is no recommended substitute class as the user was adequately engaged with the class 504. If (at block 916) the engagement score 518 is below the engagement threshold, then control proceeds to block 920 in FIG. 9B.

At block 920, if the challenge level 520 is below a low threshold, indicating the course is not a challenge or too easy, e.g., the user is bored, then the engagement adjuster 208 determines (at block 922) a new class substantially similar to content of the rendered class with a complexity level one level higher than the rendered class for which the engagement score 518 was calculated. If (at block 920) the challenge level 520 is above a high threshold, indicating the course is too much of a challenge, too difficult and frustrating, then the engagement adjuster 208 determines (at block 924) a new class substantially similar to content of the rendered class with a complexity level one level lower than the rendered class. The engagement adjuster 208 may then update (at block 926) the class recommendation data structure 500; to set the recommended next class 522 to the determined new class and set the recommend field 524 to indicate a new class recommended. Information on the new class with a link to enroll is provided (at block 928) to the user. The engagement adjustor 208 may further generate (at block 930) a training instance 600i, to add to the training set 600 for the engagement score initializer 140, indicating class complexity level 606, domain 604, user knowledge level 608 of observed user, initial engagement score 612, and calculated engagement score 610.

With the embodiment of FIGS. 9A and 9B, an engagement score is calculated based on observations of the user observing the class in the media renderer 102 gathered by user feedback devices 110 and emotional states and relevant behaviors calculated from the observed user. This engagement score may then be used to determine the extent to which the user is actively engaged with the class to determine whether a more difficult or less difficult course or content should be recommended. Further, if a new class is needed, then a training set 600; may be generated to train the engagement score initializer 140 machine learning model to avoid producing an engagement score indicating to take the class that did not have a real-time determined engagement score or challenge level satisfying thresholds.

FIG. 10 illustrates a graph of the engagement score 518 on the y-axis and the challenge level 520 component on the x-axis to illustrate the interplay of the engagement score 518 and the challenge level 520 to show how the calculated information reflects the user engagement and understanding of the rendered content.

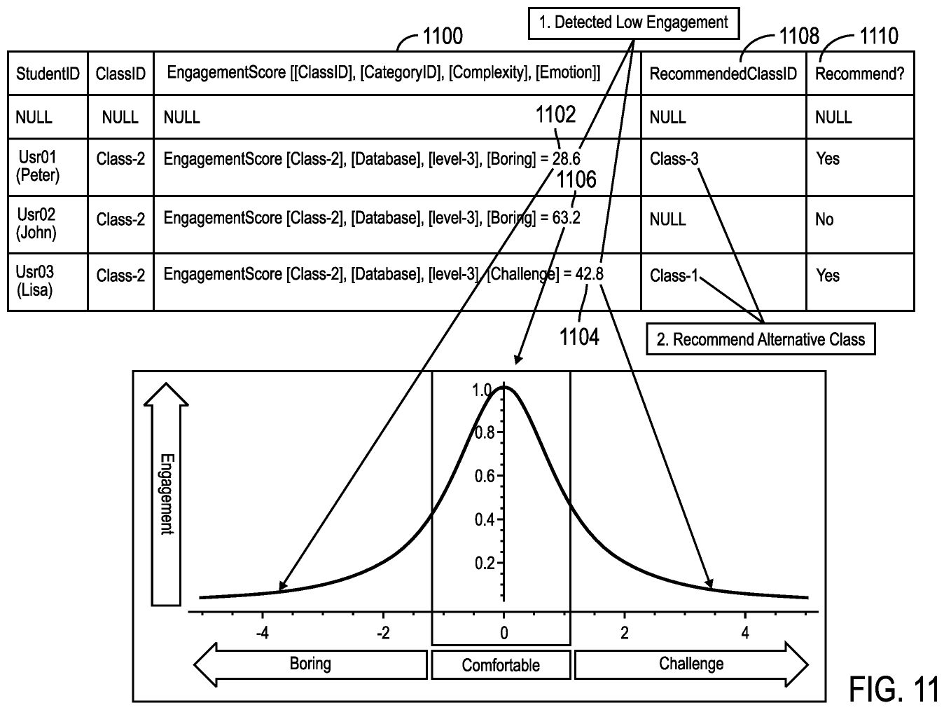

FIG. 11 illustrates an example of information in a table 1100 for different users and engagement scores showing Peter and Lisa have low engagement scores 1102, 1104 and John has a high engagement score 1106 for “class-2”, complexity level 3, and accompanying emotions. The recommended class 1108 shows next classes for Peter and Lisa, where Peter is recommended a more complex class-3 and Lisa a less complex class-1, and a recommend field 1110 indicating whether a next class is recommended given the lack of engagement for the current class-2. FIG. 11 further shows how the different scores and challenge level, “boring” or “challenge”, map to the graph of FIG. 10.

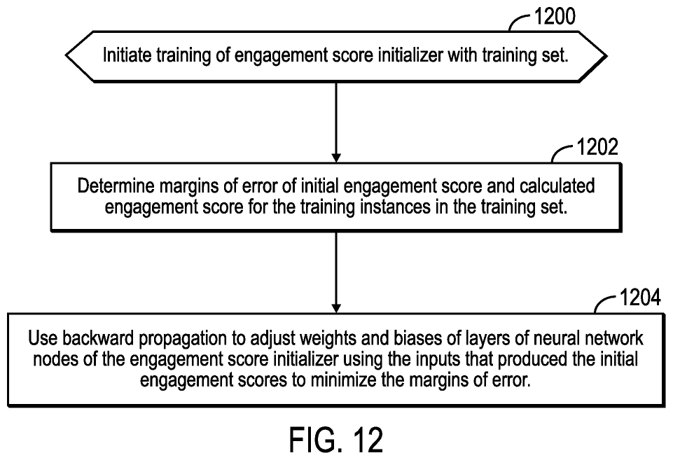

FIG. 12 illustrates an embodiment of operations performed by trainer 212 to train the engagement score initializer 140 based on the gathered training set 600 to minimize an error between the initial engagement score 612 and the calculated engagement score 610. Upon initiating (at block 1200) a training operation, with data set 600 of training data generated, the trainer 212 determines (at block 1202) margins of error of the initial engagement score 612 and the calculated engagement score 610. The trainer 212 then performs backward propagation (at block 1204) to adjust the weights and biases of layers of neural network nodes of the engagement score initializer 140 using the inputs to output the calculated engagement score 610 to minimize the margins of error. In this way, the engagement score initializer 140 weights and biases are adjusted to output engagement scores closer to the calculated engagement score 610 based on emotions and behavioral responses of the user observed at the client computer 100 while the class content is rendered.

The embodiment of FIG. 12 optimizes and trains the engagement score initializer 140 to reflect real-time calculations of engagement scores based on actual user behavior and emotions with respect to observed classes. In this way, the training modifies engagement score initializer 140 to produce initial engagement scores 300 more based on real-time user data to more accurately reflect user responses based on user knowledge in a domain.

The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

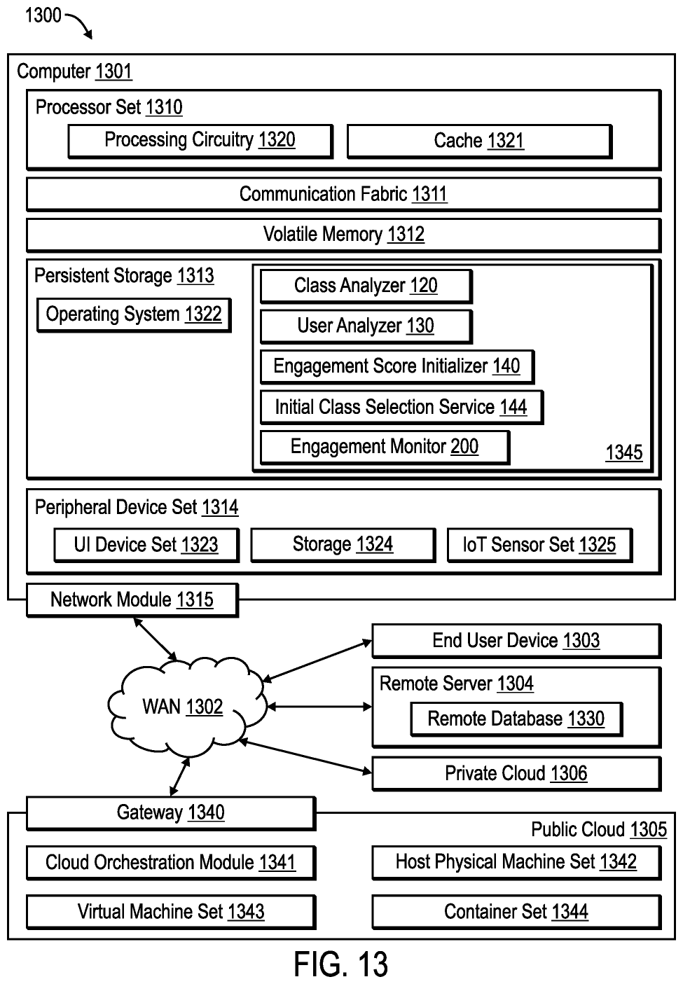

With respect to FIG. 13, computing environment 1300 contains an example of an environment for the execution of at least some of the computer code involved in performing the inventive methods, such as the class selection components in block 1345 including the class analyzer 120, the user analyzer 130, engagement score initializer 140, initial class selection service 144, and engagement monitor 200 described with respect to FIGS. 1 and 2. In addition to block 1345, computing environment 1300 includes, for example, computer 1301, wide area network (WAN) 1302, end user device (EUD) 1303, remote server 1304, public cloud 1305, and private cloud 1306. In this embodiment, computer 1301 includes processor set 1310 (including processing circuitry 1320 and cache 1321), communication fabric 1311, volatile memory 1312, persistent storage 1313 (including operating system 1322 and block 1345, as identified above), peripheral device set 1314 (including user interface (UI) device set 1323, storage 1324, and Internet of Things (IoT) sensor set 1325), and network module 1315. Remote server 1304 includes remote database 1330. Public cloud 1305 includes gateway 1340, cloud orchestration module 1341, host physical machine set 1342, virtual machine set 1343, and container set 1344.

COMPUTER 1301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1330. As is well understood in the art of computer technology, and depending upon the technology, performance of a computer-implemented method may be distributed among multiple computers and/or between multiple locations. On the other hand, in this presentation of computing environment 1300, detailed discussion is focused on a single computer, specifically computer 1301, to keep the presentation as simple as possible. Computer 1301 may be located in a cloud, even though it is not shown in a cloud in FIG. 13. On the other hand, computer 1301 is not required to be in a cloud except to any extent as may be affirmatively indicated.

PROCESSOR SET 1310 includes one, or more, computer processors of any type now known or to be developed in the future. Processing circuitry 1320 may be distributed over multiple packages, for example, multiple, coordinated integrated circuit chips. Processing circuitry 1320 may implement multiple processor threads and/or multiple processor cores. Cache 1321 is memory that is located in the processor chip package(s) and is typically used for data or code that should be available for rapid access by the threads or cores running on processor set 1310. Cache memories are typically organized into multiple levels depending upon relative proximity to the processing circuitry. Alternatively, some, or all, of the cache for the processor set may be located “off chip.” In some computing environments, processor set 1310 may be designed for working with qubits and performing quantum computing.

Computer readable program instructions are typically loaded onto computer 1301 to cause a series of operational steps to be performed by processor set 1310 of computer 1301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1321 and the other storage media discussed below. The program instructions, and associated data, are accessed by processor set 1310 to control and direct performance of the inventive methods. In computing environment 1300, at least some of the instructions for performing the inventive methods may be stored in block 1345 in persistent storage 1313.

COMMUNICATION FABRIC 1311 is the signal conduction path that allows the various components of computer 1301 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1312 is any type of volatile memory now known or to be developed in the future. Examples include dynamic type random access memory (RAM) or static type RAM. Typically, volatile memory 1312 is characterized by random access, but this is not required unless affirmatively indicated. In computer 1301, the volatile memory 1312 is located in a single package and is internal to computer 1301, but, alternatively or additionally, the volatile memory may be distributed over multiple packages and/or located externally with respect to computer 1301.

PERSISTENT STORAGE 1313 is any form of non-volatile storage for computers that is now known or to be developed in the future. The non-volatility of this storage means that the stored data is maintained regardless of whether power is being supplied to computer 1301 and/or directly to persistent storage 1313. Persistent storage 1313 may be a read only memory (ROM), but typically at least a portion of the persistent storage allows writing of data, deletion of data and re-writing of data. Some familiar forms of persistent storage include magnetic disks and solid state storage devices. Operating system 1322 may take several forms, such as various known proprietary operating systems or open source Portable Operating System Interface-type operating systems that employ a kernel. The code included in block 1345 typically includes at least some of the computer code involved in performing the inventive methods.

PERIPHERAL DEVICE SET 1314 includes the set of peripheral devices of computer 1301. Data communication connections between the peripheral devices and the other components of computer 1301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1323 may include components such as a display screen, speaker, microphone, wearable devices (such as goggles and smart watches), keyboard, mouse, printer, touchpad, game controllers, and haptic devices. Storage 1324 is external storage, such as an external hard drive, or insertable storage, such as an SD card. Storage 1324 may be persistent and/or volatile. In some embodiments, storage 1324 may take the form of a quantum computing storage device for storing data in the form of qubits. In embodiments where computer 1301 is required to have a large amount of storage (for example, where computer 1301 locally stores and manages a large database) then this storage may be provided by peripheral storage devices designed for storing very large amounts of data, such as a storage area network (SAN) that is shared by multiple, geographically distributed computers. IoT sensor set 1325 is made up of sensors that can be used in Internet of Things applications. For example, one sensor may be a thermometer and another sensor may be a motion detector.

NETWORK MODULE 1315 is the collection of computer software, hardware, and firmware that allows computer 1301 to communicate with other computers through WAN 1302. Network module 1315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1315 are performed on the same physical hardware device. In other embodiments (for example, embodiments that utilize software-defined networking (SDN)), the control functions and the forwarding functions of network module 1315 are performed on physically separate devices, such that the control functions manage several different network hardware devices. Computer readable program instructions for performing the inventive methods can typically be downloaded to computer 1301 from an external computer or external storage device through a network adapter card or network interface included in network module 1315.

WAN 1302 is any wide area network (for example, the internet) capable of communicating computer data over non-local distances by any technology for communicating computer data, now known or to be developed in the future. In some embodiments, the WAN 1302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1303 is any computer system that is used and controlled by an end user (for example, a customer of an enterprise that operates computer 1301), and may take any of the forms discussed above in connection with computer 1301. EUD 1303 typically receives helpful and useful data from the operations of computer 1301. For example, in a hypothetical case where computer 1301 is designed to provide a recommendation to an end user, this recommendation would typically be communicated from network module 1315 of computer 1301 through WAN 1302 to EUD 1303. In this way, EUD 1303 can display, or otherwise present, the recommendation to an end user. In some embodiments, EUD 1303 may be a client device, such as thin client, heavy client, mainframe computer, desktop computer and so on. The EUD 1303 may comprise the client computer 100 in FIG. 1, including components 102, 108, 110, 116.

REMOTE SERVER 1304 is any computer system that serves at least some data and/or functionality to computer 1301. Remote server 1304 may be controlled and used by the same entity that operates computer 1301. Remote server 1304 represents the machine(s) that collect and store helpful and useful data for use by other computers, such as computer 1301. For example, in a hypothetical case where computer 1301 is designed and programmed to provide a recommendation based on historical data, then this historical data may be provided to computer 1301 from remote database 1330 of remote server 1304.

PUBLIC CLOUD 1305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1305 is performed by the computer hardware and/or software of cloud orchestration module 1341. The computing resources provided by public cloud 1305 are typically implemented by virtual computing environments that run on various computers making up the computers of host physical machine set 1342, which is the universe of physical computers in and/or available to public cloud 1305. The virtual computing environments (VCEs) typically take the form of virtual machines from virtual machine set 1343 and/or containers from container set 1344. It is understood that these VCEs may be stored as images and may be transferred among and between the various physical machine hosts, either as images or after instantiation of the VCE. Cloud orchestration module 1341 manages the transfer and storage of images, deploys new instantiations of VCEs and manages active instantiations of VCE deployments. Gateway 1340 is the collection of computer software, hardware, and firmware that allows public cloud 1305 to communicate through WAN 1302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1306 is similar to public cloud 1305, except that the computing resources are only available for use by a single enterprise. While private cloud 1306 is depicted as being in communication with WAN 1302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1305 and private cloud 1306 are both part of a larger hybrid cloud.

The letter designators, such as i and n, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for recommending content to a user, wherein the computer program product comprises a computer readable storage medium having computer readable program instructions that when executed perform operations, the operations comprising:
receiving a request, from a requesting user, for a content instance in a requested domain;
determining, by an engagement score initializer, an initial engagement score, for the requesting user, based on the requested domain, a complexity level of the content instance and a knowledge level of the user;
determining whether the initial engagement score, for the requesting user, exceeds an engagement threshold; and
providing the content instance to render at a client system of the requesting user in response to the initial engagement score exceeding the engagement threshold.

2. The computer program product of claim 1, wherein the operations further comprise:
obtaining feedback, from the client system of the requesting user, indicating a classification of a user reaction to the content instance rendered at the client system;
calculating an engagement score based on the classification of the user reaction;
determining whether the engagement score exceeds a threshold value; and
training the engagement score initializer, comprising a machine learning model classifier, to minimize a difference of the initial engagement score and the engagement score for the content instance for the knowledge level of the requesting user and the requested domain in response to determining that the engagement score does not exceed the threshold value.

3. The computer program product of claim 2, wherein the classification of the user reaction comprises relevant behavior scores of behaviors of the user when observing the content instance, wherein the engagement score is calculated based on the relevant behavior scores.

4. The computer program product of claim 2, wherein the classification of the user reaction comprises an emotional state of the requesting user observing the content instance rendered at a system of the requesting user, wherein the engagement score is calculated based on the emotional state of the requesting user.

5. The computer program product of claim 2, wherein the classification of the user reaction results in relevant behavior scores of behaviors of the user and emotional states of the requesting user observing the content instance rendered at a system of the requesting user, wherein the calculating the engagement score comprises:
calculating a behavioral component score as a sum of weightings of the relevant behavior scores;
calculating an emotional component score based on a sum of weightings of the emotional state; and
calculating the engagement score as a sum of weightings of the behavioral component score and the emotional component score.

6. The computer program product of claim 1, wherein the operations further comprise:
obtaining feedback, from the client system of the requesting user, indicating a classification of a user reaction to the content instance rendered at the client system;
calculating an engagement score based on the classification of the user reaction;
determining whether the engagement score exceeds a threshold; and
determining a new content instance for the requesting user in response to determining that the engagement score does not exceed the threshold.

7. The computer program product of claim 6, wherein the determining the new content instance comprises:
determining, by a challenge classifier, a challenge classification based on the obtained feedback, wherein the challenge classification indicates whether the content instance was challenging or not challenging for the requesting user to comprehend, wherein the new content instance comprises a content instance in the requested domain having a complexity level greater than the complexity level of the content instance in response to the challenge classification indicating the content instance was not challenging for the requesting user, and wherein the new content instance comprises a content instance in the requested domain having a complexity level less than the complexity level of the content instance in response to the challenge classification indicating the content instance was challenging for the requesting user.

8. The computer program product of claim 1, wherein the engagement score initializer comprises a machine learning model, wherein the operations further comprise:
obtaining feedback, from the client system of the requesting user, indicating a classification of a user reaction to the content instance rendered at the client system;
calculating an engagement score based on the classification of the user reaction;
determining whether the engagement score exceeds a threshold value;
generating a training set instance indicating the content instance, the complexity level and the requested domain of the content instance, the knowledge level of the requesting user, the initial engagement score, and the calculated engagement score in response to determining that the calculated engagement score does not exceed the threshold value; and
training, the engagement score initializer, to output the calculated engagement score indicated in the training set instance with input comprising the knowledge level of the requesting user, and the complexity level and the requested domain of the content instance.

9. The computer program product of claim 1, wherein the engagement threshold is indicated in criteria for the content instance, wherein criteria for different content instances indicate different engagement thresholds, wherein the criteria for the content instance indicates requirements of the user to receive the content instance, further comprising:
determining whether the requesting user satisfies the requirements of the user indicated in the criteria of the content instance, wherein the content instance is provided to the requesting user in response to the initial engagement score exceeding the engagement threshold indicated in the criteria of the content instance and in response to the requesting user satisfying the requirements of the user indicated in the criteria of the content instance.

10. A system for recommending content to a user, comprising:
a processor; and
a computer readable storage medium having computer readable program instructions that when executed by the processor perform operations, the operations comprising:
receiving a request, from a requesting user, for a content instance in a requested domain;
determining, by an engagement score initializer, an initial engagement score, for the requesting user, based on the requested domain, a complexity level of the content instance and a knowledge level of the user;
determining whether the initial engagement score, for the requesting user, exceeds an engagement threshold; and
providing the content instance to render at a client system of the requesting user in response to the initial engagement score exceeding the engagement threshold.

11. The system of claim 10, wherein the operations further comprise:
obtaining feedback, from the client system of the requesting user, indicating a classification of a user reaction to the content instance rendered at the client system;
calculating an engagement score based on the classification of the user reaction;
determining whether the engagement score exceeds a threshold value; and
training the engagement score initializer, comprising a machine learning model classifier, to minimize a difference of the initial engagement score and the engagement score for the content instance for the knowledge level of the requesting user and the requested domain in response to determining that the engagement score does not exceed the threshold value.

12. The system of claim 11, wherein the classification of the user reaction results in relevant behavior scores of behaviors of the user and emotional states of the requesting user observing the content instance rendered at a system of the requesting user, wherein the calculating the engagement score comprises:
calculating a behavioral component score as a sum of weightings of the relevant behavior scores;
calculating an emotional component score based on a sum of weightings of the emotional state; and
calculating the engagement score as a sum of weightings of the behavioral component score and the emotional component score.

13. The system of claim 10, wherein the operations further comprise:
obtaining feedback, from the client system of the requesting user, indicating a classification of a user reaction to the content instance rendered at the client system;
calculating an engagement score based on the classification of the user reaction;
determining whether the engagement score exceeds a threshold; and
determining a new content instance for the requesting user in response to determining that the engagement score does not exceed the threshold.

14. The system of claim 12, wherein the determining the new content instance comprises:
determining, by a challenge classifier, a challenge classification based on the obtained feedback, wherein the challenge classification indicates whether the content instance was challenging or not challenging for the requesting user to comprehend, wherein the new content instance comprises a content instance in the requested domain having a complexity level greater than the complexity level of the content instance in response to the challenge classification indicating the content instance was not challenging for the requesting user, and wherein the new content instance comprises a content instance in the requested domain having a complexity level less than the complexity level of the content instance in response to the challenge classification indicating the content instance was challenging for the requesting user.

15. The system of claim 10, wherein the engagement score initializer comprises a machine learning model, wherein the operations further comprise:
obtaining feedback, from the client system of the requesting user, indicating a classification of a user reaction to the content instance rendered at the client system;
calculating an engagement score based on the classification of the user reaction;
determining whether the engagement score exceeds a threshold value;
generating a training set instance indicating the content instance, the complexity level and the requested domain of the content instance, the knowledge level of the requesting user, the initial engagement score, and the calculated engagement score in response to determining that the calculated engagement score does not exceed the threshold value; and
training, the engagement score initializer, to output the calculated engagement score indicated in the training set instance with input comprising the knowledge level of the requesting user, and the complexity level and the requested domain of the content instance.

16. A computer implemented method for recommending content to a user, comprising:
receiving a request, from a requesting user, for a content instance in a requested domain;
determining, by an engagement score initializer, an initial engagement score, for the requesting user, based on the requested domain, a complexity level of the content instance and a knowledge level of the user;
determining whether the initial engagement score, for the requesting user, exceeds an engagement threshold; and
providing the content instance to render at a client system of the requesting user in response to the initial engagement score exceeding the engagement threshold.

17. The method of claim 16, further comprising:
obtaining feedback, from the client system of the requesting user, indicating a classification of a user reaction to the content instance rendered at the client system;
calculating an engagement score based on the classification of the user reaction;
determining whether the engagement score exceeds a threshold value; and
training the engagement score initializer, comprising a machine learning model classifier, to minimize a difference of the initial engagement score and the engagement score for the content instance for the knowledge level of the requesting user and the requested domain in response to determining that the engagement score does not exceed the threshold value.

18. The method of claim 17, wherein the classification of the user reaction results in relevant behavior scores of behaviors of the user and emotional states of the requesting user observing the content instance rendered at a system of the requesting user, wherein the calculating the engagement score comprises:
calculating a behavioral component score as a sum of weightings of the relevant behavior scores;
calculating an emotional component score based on a sum of weightings of the emotional state; and
calculating the engagement score as a sum of weightings of the behavioral component score and the emotional component score.

19. The method of claim 16, further comprising:
obtaining feedback, from the client system of the requesting user, indicating a classification of a user reaction to the content instance rendered at the client system;
calculating an engagement score based on the classification of the user reaction;
determining whether the engagement score exceeds a threshold; and
determining a new content instance for the requesting user in response to determining that the engagement score does not exceed the threshold.

20. The method of claim 16, wherein the determining the new content instance comprises:
determining, by a challenge classifier, a challenge classification based on the obtained feedback, wherein the challenge classification indicates whether the content instance was challenging or not challenging for the requesting user to comprehend, wherein the new content instance comprises a content instance in the requested domain having a complexity level greater than the complexity level of the content instance in response to the challenge classification indicating the content instance was not challenging for the requesting user, and wherein the new content instance comprises a content instance in the requested domain having a complexity level less than the complexity level of the content instance in response to the challenge classification indicating the content instance was challenging for the requesting user.
